(19) United States
(12) Patent Application Publication
(10) Pub. No.: US 2025/0242287 A1
(43) Pub. Date: Jul. 31, 2025

(54) CHEMICAL FILTER AND METHOD OF MANUFACTURING THE SAME

(71) Applicant: ECOPROHN CO., LTD., Chungcheongbuk-do (KR)

(72) Inventors: TAI JIN YOON, Chungcheongbuk-do (KR); JONG GEUN KIM, Chungcheongbuk-do (KR); SEUNG BIN LEE, Chungcheongbuk-do (KR); KI EUNG LEE, Chungcheongbuk-do (KR); JEONG HUN KIM, Chungcheongbuk-do (KR); JUNG SU KIM, Chungcheongbuk-do (KR)

(21) Appl. No.: 19/021,459

(22) Filed: Jan. 15, 2025

(30) Foreign Application Priority Data
Jan. 30, 2024 (KR) 10-2024-0013607

(51) Int. Cl. B01D 46/52; B01D 46/00

(52) U.S. Cl. CPC B01D 46/523; B01D 46/0001; B01D 46/0005

(57) ABSTRACT

A chemical filter includes a chemical filter media, and a resin layer formed on an outer surface of the chemical filter media and having a tensile strength of 20 kgf/cm² to 90 kgf/cm². The chemical filter may have improved durability and impact resistance, and improved filter performance. In a method of manufacturing a chemical filter, a chemical filter media is prepared, the chemical filter media is bent in a zigzag shape, and a hot-melt resin is applied to the outer surface of the chemical filter media to form a resin layer.

### CROSS REFERENCE TO RELATED APPLICATION AND CLAIM OF PRIORITY

This application claims the benefit under 35 USC § 119 of Korean Patent Application Nos. 10-2024-0013607 filed on Jan. 30, 2024 in the Korean Intellectual Property Office, the entire disclosure of which is incorporated herein by reference for all purposes.

### BACKGROUND

### 1. Field of the Invention

The present invention relates to a chemical filter and a method of manufacturing the same, and more specifically, to a chemical filter which includes an adsorbent.

### 2. Description of the Related Art

In a semiconductor process and/or a display process, chemical contaminants such as acidic gases (NOₓ, SOₓ, HCl, HF, organic acids, etc.), basic gases (NH₃, amines, etc.), organic sulfur compounds, volatile organic compounds (VOCs), and the like may be generated. Harmful gases including the above-described chemical contaminants may cause environmental pollution, and are toxic to a respiratory organ, nervous system, etc. of the human body.

A chemical filter may be used in various industrial fields such as a semiconductor process, display process, and machine assembly process to adsorb and remove chemical contaminants in the air. For example, the chemical contaminants included in the harmful gas may be removed while the harmful gas passes through a filter media including an adsorbent.

The chemical filter may be provided in a state where the filter media is assembled into a frame or case. For example, in order to fix the filter media to the frame or case, an adhesive may be applied between the filter media and the frame.

However, in this case, since it is difficult to separate the filter media from the frame due to the adhesive, when the lifespan of the filter media ends, the frame may also be discarded together with the filter media. Further, even if the filter media is separated from the frame, an adhesive component may remain in the frame, and new chemical contaminants may be generated during removing the adhesive component.

Therefore, it is necessary to develop a chemical filter which allows replacement of only the filter media without discarding the frame, while not causing a decrease in the filter performance and lifespan. For example, Korean Patent Laid-Open Publication No. 10-2014-0072083 discloses an air filter, but the improvement is insufficient.

### SUMMARY

An object of the present invention is to provide a chemical filter having improved strength, durability and harmful gas removal performance.

Another object of the present invention is to provide a method of manufacturing the chemical filter having improved strength, durability and harmful gas removal performance.

To achieve the above object, according to an aspect of the present invention, there is provided a chemical filter including: a chemical filter media; and a resin layer which is formed on an outer surface of the chemical filter media and has a tensile strength of 20 kgf/cm² to 90 kgf/cm².

In some embodiments, the resin layer may have an elongation of 20% to 350%.

In some embodiments, the resin layer may have a maximum load of 4 kgf to 20 kgf.

In some embodiments, the resin layer may have a thickness of 1.0 mm to 10.0 mm.

In some embodiments, the resin layer may include a hot-melt resin.

In some embodiments, the resin layer may include an ethylene-based copolymer.

In some embodiments, the outer surface of the chemical filter media may include a first surface and a second surface which face each other in a longitudinal direction, and a third surface and a fourth surface which face each other in a width direction perpendicular to the longitudinal direction.

In some embodiments, the resin layers may be formed on the first surface and the second surface.

In some embodiments, the chemical filter may further include a support member which is coupled to the third surface and the fourth surface of the chemical filter media.

In some embodiments, the resin layers may be formed on all of the first surface, the second surface, the third surface and the fourth surface.

In some embodiments, the chemical filter media may include a plurality of bent portions, which may extend in a zigzag shape in the width direction.

In some embodiments, the plurality of bent portions may include grooves and ridges which are alternately repeated in the width direction.

In some embodiments, the chemical filter may further include a filter frame in which the chemical filter media is housed.

In some embodiments, the resin layer may be in direct contact with the filter frame.

According to another aspect of the present invention, there is provided a method of manufacturing a chemical filter, the method including: preparing a chemical filter media; bending the chemical filter media in a zigzag shape; and applying a hot-melt resin to the outer surface of the chemical filter media to form a resin layer, wherein the resin layer has a tensile strength adjusted to 20 kgf/cm² to 90 kgf/cm².

In some embodiments, the method may further include assembling the chemical filter media on which the resin layer is formed to a filter frame.

In some embodiments, the chemical filter media may be coupled to the filter frame so that the resin layer is fixed by coming into contact with the filter frame.

According to exemplary embodiments, the chemical filter may include the filter media and the resin layer formed on an outer surface of the filter media. The resin layer has a tensile strength within a predetermined range, such that durability and impact resistance of the chemical filter may be improved. In addition, the resin layer may be uniformly formed on the outer surface of the filter media without generating bubbles, and an air path passing through the filter may be enhanced, thereby improving differential pressure performance.

The filter media may be easily separated from and coupled to the filter frame by the resin layer without causing damage or contamination in the filter frame. Accordingly, only the filter media may be replaced independently, such that the filter frame may be reused, and operation costs may be reduced and economic advantages may be improved.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a filter media according to exemplary embodiments;

FIG. 2 is a schematic view illustrating a chemical filter according to exemplary embodiments;

FIG. 3 is a schematic plan view illustrating the chemical filter according to exemplary embodiments;

FIG. 4 is a schematic top view illustrating a region A of FIG. 2;

FIG. 5 is a schematic view illustrating a chemical filter according to exemplary embodiments;

FIG. 6 is a schematic view illustrating a chemical filter according to exemplary embodiments;

FIG. 7 is a schematic view illustrating a state before coupling the filter media with a filter frame;

FIG. 8 is an enlarged view illustrating a region B of FIG. 6;

FIGS. 9A and 9B are a plan image and an upper portion image obtained by photographing a chemical filter according to Comparative Example 1, respectively;

FIGS. 10A and 10B are a plan image and an upper portion image obtained by photographing a chemical filter according to Comparative Example 2, respectively;

FIGS. 11A and 11B are a plan image and an upper portion image obtained by photographing a chemical filter according to Example 1, respectively;

FIG. 12 is a graph illustrating differential pressures of the chemical filters of Examples 1 to 3 and Comparative Example 3.

### DETAILED DESCRIPTION OF THE INVENTION

A chemical filter according to embodiments of the present invention includes a filter media and a resin layer formed on an outer surface of the filter media.

Hereinafter, the present invention will be described in detail through embodiments with reference to the accompanying drawings. However, the embodiments are merely illustrative and the present invention is not limited to the specific embodiments described by way of example.

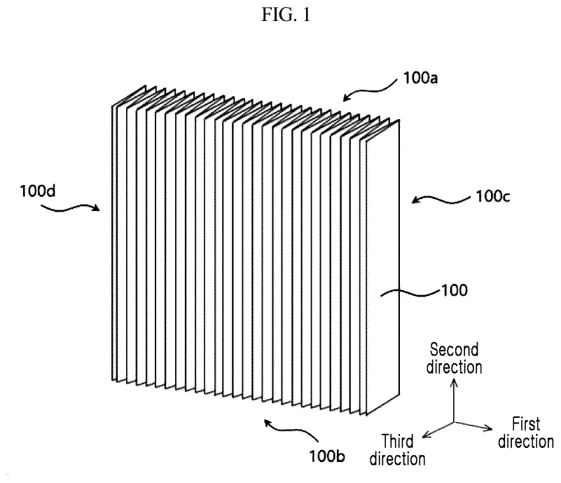

FIG. 1 is a schematic view illustrating a chemical filter media (hereinafter, may be abbreviated as a filter media) according to exemplary embodiments.

Referring to FIG. 1, a filter media 100 may be bent in a zigzag shape. For example, the filter media 100 may have a zigzag shape extending in a width direction (e.g., a first direction).

The filter media 100 may include a filter layer, thus to adsorb or remove harmful substances included in the air passing through the filter media 100.

For example, the term “harmful substance” or “harmful gas” as used herein may include acidic gases (NOₓ, SOₓ, HCl, HF, organic acids, etc.), basic gases (NH₃, amines, etc.), volatile organic compounds (VOCs) and the like.

In one embodiment, the filter layer may be formed by attaching or stacking an adsorbent material to a filter support. The adsorbent material may include an adsorbent such as activated carbon, an ion exchange resin, metal oxide powder, etc.

The filter support may include a material having gas permeability. For example, a fiber sheet such as a nonwoven fabric, a fabric, a filter paper, etc., or a porous foam such as a sponge, etc., may be used as the filter support.

In one embodiment, the filter media 100 may include a plurality of filter layers. For example, the filter media 100 may have a multi-layered structure in which at least two or more filter layers are stacked in a third direction.

The filter layers may include the same adsorbent material as each other, or may include different adsorbent materials from each other. For example, organic contaminants may be removed from one filter layer, and inorganic contaminants may be removed from another filter layer.

According to exemplary embodiments, the filter media 100 may have a polyhedral shape having a plurality of outer surfaces. For example, the filter media 100 may have a hexahedral shape.

In some embodiments, the outer surface of the filter media 100 may include a first surface 100a and a second surface 100b which face in a longitudinal direction (e.g., a second direction), and a third surface 100c and a fourth surface 100d which face in the width direction. The longitudinal direction may be perpendicular to the width direction.

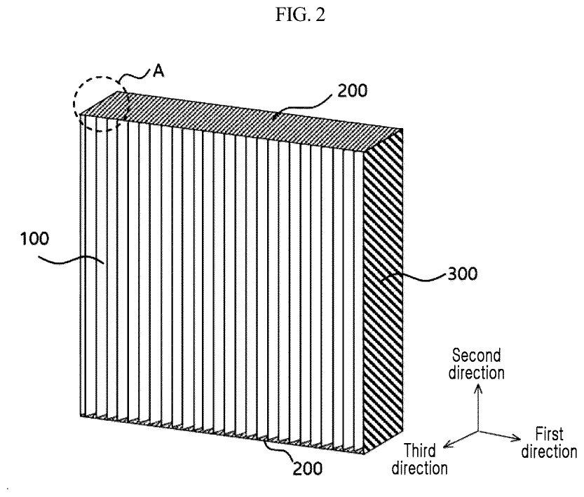

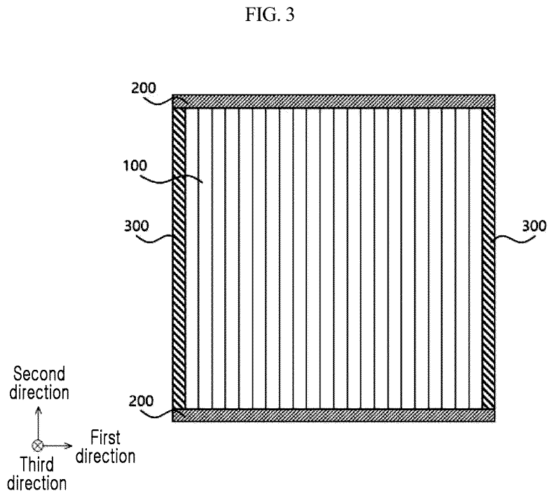

FIG. 2 is a schematic view illustrating a chemical filter according to exemplary embodiments. FIG. 3 is a schematic plan view illustrating the chemical filter according to exemplary embodiments. For example, FIG. 3 is a plan view of the chemical filter shown in FIG. 2 when observed in the third direction.

Referring to FIGS. 2 and 3, the chemical filter may include a resin layer 200 formed on the outer surface of the filter media 100.

The resin layer 200 may be in direct contact with the outer surface of the filter media 100. For example, the resin layer 200 may be formed by applying a composition for forming a resin layer to the outer surface of at least one of the first surface 100a, the second surface 100b, the third surface 100c and the fourth surface 100d, followed by curing the same.

The resin layer 200 may have a tensile strength of 20 kgf/cm² to 90 kgf/cm². Within the above range, durability and impact resistance of the chemical filter may be improved. In addition, the resin layer may be uniformly formed on the outer surface of the filter media without generating bubbles, and an air path passing through the filter may be enhanced, thereby improving the differential pressure performance.

For example, when the tensile strength of the resin layer is greater than 90 kgf/cm², bubbles may be generated inside the resin layer or the resin layer may be formed unevenly during a process of forming the resin layer. In this case, rather cracks may occur in the resin layer, and air may leak through the resin layer, thereby reducing an amount of air passing therethrough, as well as a pressure loss may be increased, thus to cause a decrease in the filter performance.

For example, when the tensile strength of the resin layer is less than 20 kgf/cm², the cushioning performance against an external impact may be decreased, and mechanical and thermal damage to the resin layer and the filter media may be increased due to the increased brittleness.

In some embodiments, the resin layer 200 may have a tensile strength of 20 kgf/cm² to 90 kgf/cm², 21 kgf/cm² to 89 kgf/cm², 21 kgf/cm² to 87 kgf/cm², or 50 kgf/cm² to 87 kgf/cm².

In one embodiment, the tensile strength of the resin layer 200 may be measured using a universal test machine (UTM) according to the KS M ISO 37:2017 standard. For example, using a dumbbell-shaped 1-type specimen as a test specimen, a thickness may be set to be 3 mm, and a length of the marked line may be set to be 2.5 cm, then the measurement may be performed under a condition of a moving speed of 500 mm/min.

According to exemplary embodiments, the resin layer 200 may have an elongation of 20% to 350%. Within the above range, the mechanical strength and durability of the resin layer 200 may be improved, while cushioning properties against the external impact may be further enhanced.

In some embodiments, the resin layer 200 may have an elongation of 20% to 300%, 20% to 200%, 25% to 170%, or 50% to 150%.

In one embodiment, the elongation of the resin layer 200 may be measured using the universal test machine (UTM) according to the KS M ISO 37:2017 standard.

According to exemplary embodiments, the resin layer 200 may have a maximum load of 4 kgf to 20 kgf. Within the above range, the impact resistance and durability may be further improved while improving the light weight of the chemical filter.

In some embodiments, the resin layer 200 may have a maximum load of 4 kgf to 17 kgf, 4 kgf to 16 kgf, or 9 kgf to 16 kgf.

In one embodiment, the maximum load of the resin layer 200 may be measured using the universal test machine (UTM) according to the KS M ISO 37:2017 standard.

According to exemplary embodiments, the resin layer 200 may have a thickness of 1.0 mm to 10.0 mm, 1.2 mm to 9.0 mm, 1.2 mm to 6.0 mm, or 1.5 mm to 6.0 mm. Within the above range, the filter media 100 may be easily fixed by the resin layer 200, and air leakage may be suppressed, thereby improving the removal performance of the filter. In addition, the durability and impact resistance of the chemical filter may be further improved.

In some embodiments, a maximum displacement of the resin layer 200 may be greater than 0 cm and 9 cm or less. Within the above range, it is possible to prevent the resin layer 200 from being broken or fractured due to an external impact, and the durability and stability of the chemical filter may be further improved.

In one embodiment, the maximum displacement of the resin layer 200 may be measured using the universal test machine (UTM) according to the KS M ISO 37:2017 standard.

In one embodiment, the maximum displacement of the resin layer 200 may be from 1.0 cm to 8.0 cm, 1.0 cm to 7.0 cm, 1.0 cm to 5.0 cm, or 1.0 cm to 4.5 cm.

In some embodiments, the resin layer 200 may include a hot-melt resin. For example, the hot-melt adhesive may be applied to the outer surface of the filter media 100 to form the resin layer 200.

When forming the resin layer 200 using the hot-melt resin, the resin layer 200 having a uniform shape may be more easily formed on the outer surface of the filter media 100.

In one embodiment, the hot-melt resin may have a softening point of 100° C. to 180° C., 105° C. to 150° C., or 110° C. to 130° C. Within the above range, the high temperature durability of the chemical filter may be improved, and contamination of the filter frame due to the elution of the hot-melt resin may be suppressed.

In one embodiment, the resin layer 200 may include an ethylene-based copolymer as the hot-melt resin.

In one embodiment, a content of the hot-melt resin based on a total weight of the resin layer 200 may be 90% by weight (“wt %”) or more, 95 wt % or more, or 99 wt % or more. For example, the resin layer 200 may not include fibers such as nonwoven fabrics, other resin components, or polymers in addition to the hot-melt resin. Accordingly, the tensile strength, elongation and maximum load of the resin layer 200 may be easily adjusted within a desired range.

In some embodiments, the hot-melt resin may include a polymer such as an ethylene-based copolymer, or polyolefin, etc., a petroleum resin such as a hydrocarbon, or hydrogenated hydrocarbon resin, etc.

In one embodiment, the hot-melt resin may include an ethylene copolymer and/or hydrogenated hydrocarbon.

In one embodiment, a content of the polymer may be 50 wt % or more based on a total weight of the hot-melt adhesive, and may be, for example, 50 wt % to 70 wt %.

In one embodiment, a content of the hydrogenated hydrocarbon may be less than 50 wt % based on the total weight of the hot-melt adhesive, and may be, for example, 30 wt % to 45 wt %, or 30 wt % to 40 wt %.

In some embodiments, the hot-melt adhesive may further include an additive. For example, the additive may include an antioxidant, and may further include a tackifier, a plasticizer, a UV stabilizer and the like.

In one embodiment, a content of the additive may be 1 wt % or less based on the total weight of the hot-melt adhesive, and may be, for example, greater than 0 wt % and less than 1 wt %.

In one embodiment, a viscosity of the hot-melt adhesive may be adjusted to 10,000 cps to 35,000 cps at a temperature of about 120° C. to 200° C.

According to exemplary embodiments, the resin layers 200 may be formed on the first surface 100a and the second surface 100b of the filter media 100.

In some embodiments, the chemical filter may further include support members 300 coupled to the third surface 100c and the fourth surface 100d of the filter media 100.

The filter media 100 may be easily fixed by the support member 300, and deformation of the filter media 100 may be suppressed. In one embodiment, the support member 300 may be coupled to the outermost bent portion of the filter media 100.

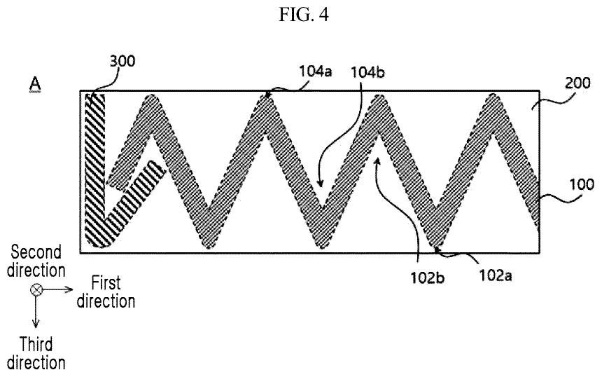

FIG. 4 is a schematic top view illustrating a region A of FIG. 2. For example, FIG. 4 is an enlarged view of the region A shown in FIG. 2 when observed in second direction.

Referring to FIG. 4, the filter media 100 may include a plurality of bent portions. The plurality of bent portions may be formed to be spaced apart from each other in the width direction.

The filter media 100 may have a zigzag shape extending in the width direction by the above-described bent portions. The filter media 100 has a wrinkled shape, such that a surface area of the filter media 100 may be increased, and the filter performance may be further improved.

The plurality of bent portions may include grooves and ridges which are alternately repeated in the width direction.

For example, first grooves 102b and first ridges 102a may be alternately formed on one surface of the filter media 100 in the width direction. For example, second grooves 104b and second ridges 104a may be alternately formed on the other surface of the filter media 100 in the width direction.

The one surface and the other surface of the filter media 100 may mean surfaces which face each other in the third direction perpendicular to the longitudinal direction and the width direction.

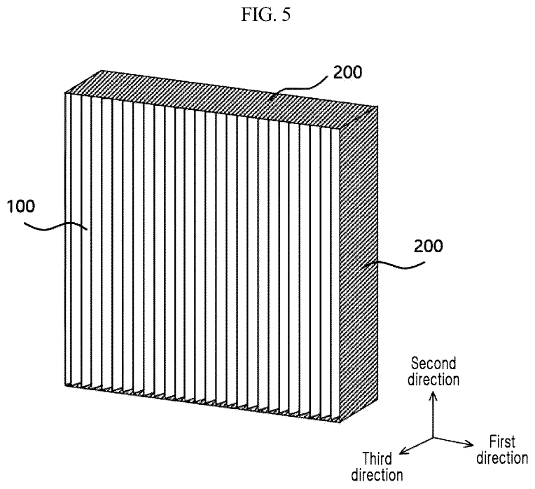

FIG. 5 is a schematic view illustrating a chemical filter according to exemplary embodiments.

Referring to FIG. 5, the resin layers 200 may be formed on all of the first surface 100a, the second surface 100b, the third surface 100c and the fourth surface 100d of the filter media 100.

As the resin layer 200 covers the entire outer surface of the filter media 100, vibrations, shocks, etc. applied to the filter media 100 may be more alleviated, and the stability of the chemical filter may be improved.

In some embodiments, the bent portion may have a height of 30 mm to 200 mm. For example, the height of the bent portion may mean a height between the first groove 102b and the first ridge 102a in the third direction, or a height between the second groove 104b and the second ridge 104a in the third direction.

Within the above range, the surface area of the filter media 100 may be increased, thereby securing the increased air passing area, and the durability and stability of the filter media 100 may be improved together with the differential pressure characteristics.

In one embodiment, the bent portion may have a height of 50 mm to 200 mm, 80 mm to 170 mm, or 90 mm to 150 mm.

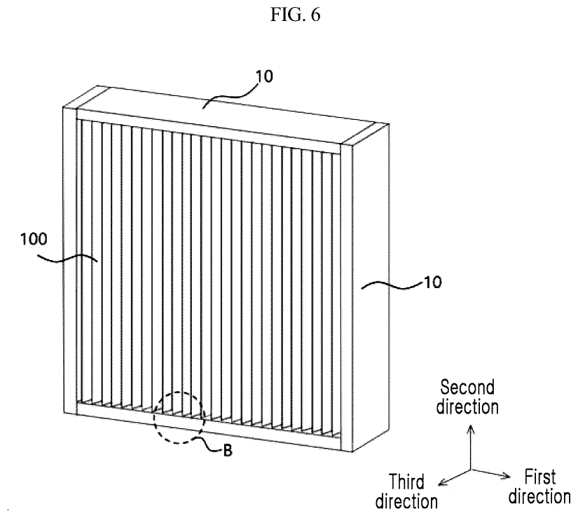

FIG. 6 is a schematic view illustrating a chemical filter according to exemplary embodiments.

Referring to FIG. 6, the chemical filter may further include a filter frame 10. The filter media 100 may be housed inside the filter frame 10.

The filter frame 10 may have the same shape as an outer shape of the filter media 100. For example, the filter frame 10 may surround the outer surface of the filter media 100.

In some embodiments, the filter frame 10 may include metals or an alloy thereof, such as aluminum, an aluminum alloy or stainless steel (SUS).

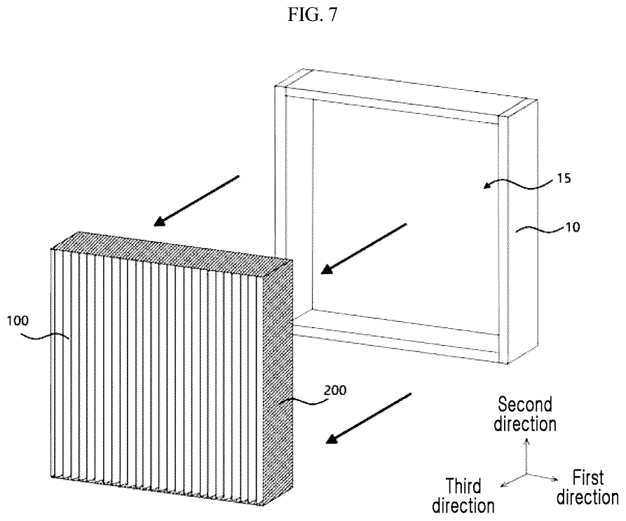

FIG. 7 is a schematic view illustrating a state before coupling the filter media with the filter frame.

Referring to FIG. 7, the filter frame 10 may include an opening 15 penetrating one surface and the other surface. For example, the filter frame 10 may have a square shape.

The filter media 100 may be inserted into the filter frame 10 through the opening 15 to be coupled, and air may pass through the filter media 100 via the opening 15. For example, the filter media 100 may be slitted according to the size of the opening 15 to be assembled to the filter frame 10.

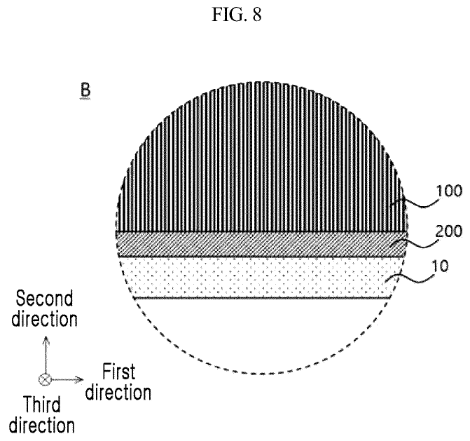

FIG. 8 is an enlarged view illustrating a region B of FIG. 6. For example, FIG. 8 is a plan view of the region B shown in FIG. 6 when observed in the third direction.

Referring to FIG. 8, the resin layer 200 may be in direct contact with the filter frame 10. For example, only the resin layer 200 may be interposed between the filter media 100 and the filter frame 10.

For example, if other materials such as a nonwoven fabric, an adhesive layer, a plastic substrate, etc. are further interposed between the filter media and the filter frame in addition to the resin layer, the size of the filter media may be reduced or the size of the chemical filter may be excessively increased due to space limitations. In addition, an amount of hot-melt resin applied to the outer surface of the filter media may be reduced, thereby causing a decrease in the tensile strength and durability.

According to exemplary embodiments, as the resin layer 200 having the above-described tensile strength is in direct contact with the filter frame 10, crack resistance and impact resistance of the chemical filter may be improved, and lifespan and efficiency may be enhanced.

In addition, since no adhesive for fixing the filter frame 10 and the resin layer 200 or the filter media 100 is required, only the filter media 100 may be replaced independently, and contamination of the filter frame 10 due to the elution of the adhesive component may be suppressed.

According to a method of manufacturing the chemical filter according to embodiments of the present invention, the chemical filter media may be bent into a zigzag shape. For example, the chemical filter media may be formed by attaching or applying an adsorbent material to a filter support having gas permeability.

The chemical filter media may be bent to include a plurality of bent portions in the width direction of the chemical filter media. For example, grooves and ridges may be alternately and repeatedly formed on one surface of the chemical filter media, and grooves and ridges may be alternately and repeatedly formed on the other surface of the chemical filter media.

A hot-melt adhesive may be applied to the outer surface of the bent chemical filter media to form a resin layer. The hot-melt adhesive may include the above-described hot-melt resin.

For example, the resin layers may be formed on both outer surfaces corresponding to the longitudinal direction of the chemical filter media.

The forming process of the resin layer may be adjusted so that the resin layer has a tensile strength adjusted to 20 kgf/cm² to 90 kgf/cm². For example, the tensile strength of the resin layer may be adjusted through process conditions such as a type of the hot-melt resin, the softening temperature, the viscosity of the hot-melt adhesive, and an application amount, application temperature, and time, etc.

In one embodiment, the hot-melt adhesive may be heated in a separate tank to maintain it in a liquid state.

In some embodiments, support members may be coupled to both outer surfaces which face each other in the width direction of the chemical filter. For example, the filter media may be easily fixed by the support member, such that easiness of the process may be further improved during the forming process of the resin layer.

In some embodiments, the resin layers may be formed on both outer surfaces which face in the longitudinal direction and both outer surfaces which face in the width direction of the chemical filter media.

For example, before forming the resin layer, the filter media may be fixed by inserting the filter media into a jig. The resin layers may be formed on both outer surfaces of the filter media fixed to the jig, and the filter media on which the resin layers are formed may be separated from the jig.

The filter media may be assembled into a filter frame.

In one embodiment, the filter media may be fixed to the filter frame so that the resin layer comes into contact with the filter frame. Therefore, the filter media may be independently separated and replaced without causing physical damage and chemical contamination in the filter frame. Accordingly, the filter frame may be reused, thereby increasing the convenience, and operation costs of the chemical filter may be reduced.

Hereinafter, the present invention will be described in detail by examples and experimental examples. The following examples and experimental examples are merely an example for describing the present invention in detail, and the content of the present invention is not limited to the following examples and experimental examples.

### EXPERIMENTAL EXAMPLES

### Example 1

### (1) Manufacturing of Chemical Filter

A hot melt binder was applied to a nonwoven fabric, and activated carbon was sprayed to prepare a chemical filter media having a size of 650 mm×1140 mm. The chemical filter media was bent in a zigzag shape, and the height of the bent portion was adjusted to 80 mm.

A hot melt resin including 59.5 wt % of ethylene copolymer, 40 wt % of hydrogenated hydrocarbon, and 0.5 wt % of antioxidant was prepared. The hot melt resin was prepared to have a viscosity of 10,000 cps to 35,000 cps at a temperature of about 120° C. to 200° C.

The chemical filter media was fixed to a jig, and the hot melt resin was sprayed on the outer surface of the chemical filter media at a temperature of about 115° C. to 180° C. and cooled to form a resin layer on the outer surface.

### (2) Measurement of Maximum Load, Tensile Strength, Elongation, and Maximum Displacement

The resin layer was cut to prepare a specimen having a size of 6.2 mm×3.0 mm. The maximum load, tensile strength, elongation, and maximum displacement were measured on the specimen using a universal test machine (UTM) according to the KS M ISO 37:2017 standard. Specifically, using a dumbbell-shaped 1-type specimen as a test specimen, a thickness was set to be 3 mm, and a length of the marked line was set to be 2.5 cm, then the measurement was performed under a condition of a moving speed of 500 mm/min.

### Comparative Example 1

A chemical filter was manufactured according to the same procedures as described in Example 1, except that a hot-melt resin including 49.5 wt % of polyolefin, 40 wt % of hydrocarbon resin, 10 wt % of wax and 0.5 wt % of antioxidant was manufactured.

### Comparative Example 2

A resin layer was prepared according to the same procedures as described in Example 1, except that a hot-melt resin including 39.5 wt % of ethylene vinylacetate copolymer, 40 wt % of hydrogenated hydrocarbon resin, 20 wt % of wax, and 0.5 wt % of antioxidant was used, and the properties of the resin layer were adjusted as shown in Table 1 below.

TABLE 1

| | Tensile | | Maximum | Maximum |
|---|---|---|---|---|
| | strength | Elongation | load | displacement |
| Division | (kgf/cm²) | (%) | (kgf) | (cm) |
| Example 1 | 22.043 | 108.82 | 4.1 | 2.7204 |
| Comparative | 6.452 | 2362.9 | 1.2 | 59.072 |
| Example 1 | | | | |
| Comparative | 91.935 | 379.52 | 17.1 | 9.488 |
| Example 2 | | | | |

### Evaluation of Cracks and Bubbles in Resin Layer

Whether cracks and bubbles occur in the resin layers of the chemical filters of Example 1, Comparative Examples 1 and 2 was visually observed.

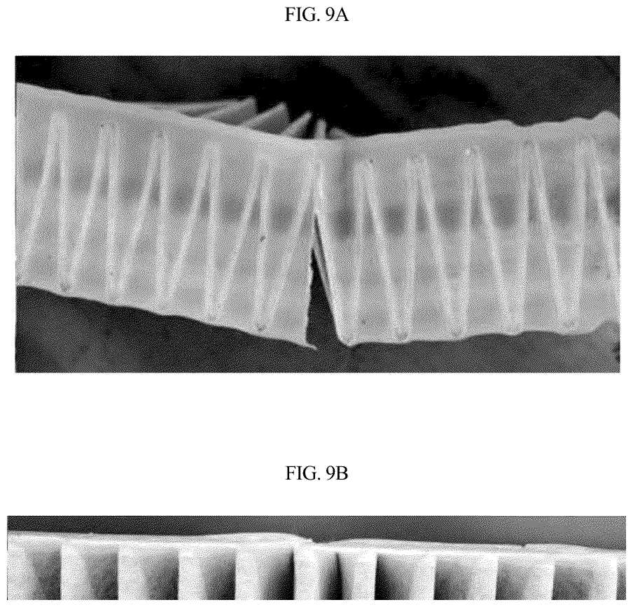

FIGS. 9A and 9B are a plan image and an upper portion image obtained by photographing a chemical filter according to Comparative Example 1, respectively.

Referring to FIGS. 9A and 9B, in the case of Comparative Example 1, the tensile strength of the resin layer was too low, such that the filter was easily bent, and cracks and tears in the resin layer occurred.

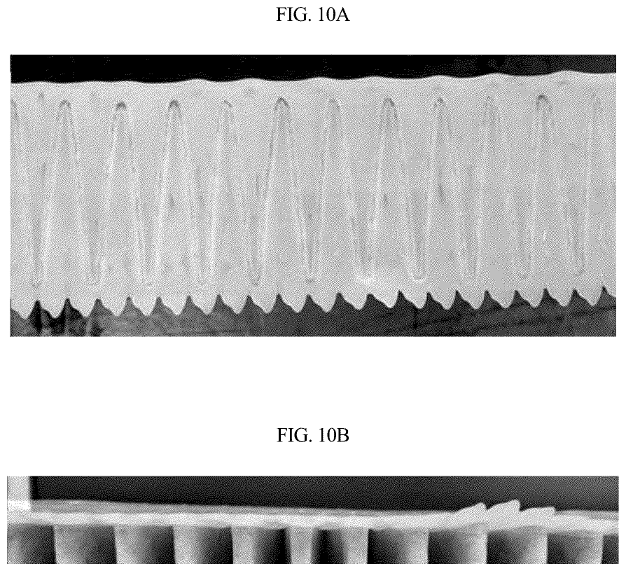

FIGS. 10A and 10B are a plan image and an upper portion image obtained by photographing a chemical filter according to Comparative Example 2, respectively.

Referring to FIGS. 10A and 10B, in the case of Comparative Example 2, the tensile strength of the resin layer was too high, such that the resin layer was not uniformly formed, and bubbles were observed in the resin layer.

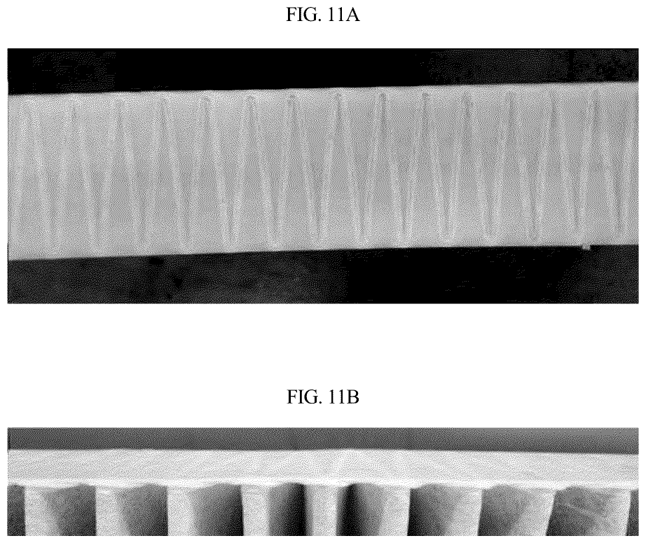

FIGS. 11A and 11B are a plan image and an upper portion image obtained by photographing a chemical filter according to Example 1, respectively.

Referring to FIGS. 11A and 11B, in the case of Example 1, the resin layer was uniformly formed on the outer surface of the filter media, and no bubbles or cracks occurred.

### Example 2

A chemical filter was manufactured according to the same procedures as described in Example 1, except that the size of the chemical filter was adjusted to 650 mm×1050 mm, and the height of the bent portion was adjusted to 100 mm.

### Example 3

A chemical filter was manufactured according to the same procedures as described in Example 1, except that the size of the chemical filter was adjusted to 650 mm×880 mm, and the height of the bent portion was adjusted to 100 mm.

### Comparative Example 3

A hot melt binder was applied to a nonwoven fabric, and activated carbon was sprayed thereon to prepare a chemical filter media having a size of 650 mm×1140 mm. The chemical filter media was bent in a zigzag shape, and the height of the bent portion was adjusted to 80 mm. An aluminum frame was temporarily assembled to the outer surface of the chemical filter media. A polyurethane adhesive was applied between the media and the frame, followed by curing the same for 30 minutes to manufacture a chemical filter.

### Evaluation of Differential Pressure Characteristics

The differential pressure characteristics of the chemical filters according to Examples 1 to 3 and Comparative Example 3 were evaluated according to the JIS B 9908 standard. Specifically, the pressure loss according to the surface wind speed was measured using a 9565-P (TSI) anemometer as an air velocity meter and a CP300 (KIMO) manometer as a differential pressure gauge at a temperature of 25° C. and a humidity of 45±5% RH using a 610 wind tunnel test device (EcoPro).

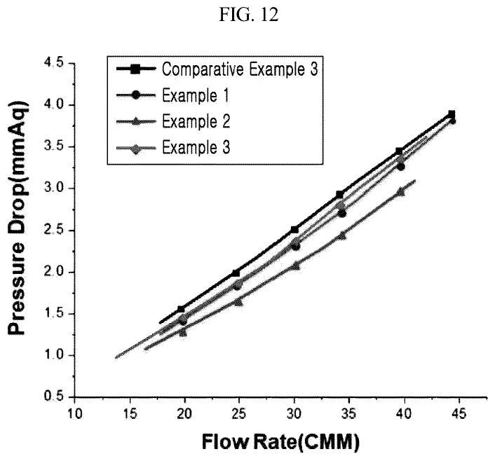

FIG. 12 is a graph illustrating differential pressures of the chemical filters of Examples 1 to 3 and Comparative Example 3.

Referring to FIG. 12, in the case of the examples, the pressure loss was reduced compared to Comparative Example 3.

### Evaluation of Initial Efficiency

Air was passed through the chemical filters according to Examples 1 to 3 and Comparative Example 3 to measure the removal efficiency for the contaminants. Specifically, the concentrations in the gas before (front end) and after (rear end) passing through the chemical filter by passing air including NH₃ and SO₂ were measured. If the contaminant was not substantially measured, it was indicated as “N.D” in Table 2 below. The removal efficiency was calculated as a ratio of the concentration at the rear end to the concentration at the front end.

The concentration of the contaminants was measured using ion chromatography analysis equipment and thermal desorption gas chromatography/mass spectrometry (TD-GC/MS) analysis equipment.

Evaluation results are shown in Table 2 below.

TABLE 2

| | | |
|---|---|---|
| | SO₄²⁻ | NH₄⁺ |
| Division | (ppbv) | (ppbv) |

| | | | |
|---|---|---|---|
| Example 1 | Front end | 8.54 | 13.52 |
| | Rear end | 0.11 | 1.25 |
| | Removal efficiency | 98.66 | 90.74 |
| | (%) | | |
| Example 2 | Front end | 5.99 | 8.62 |
| | Rear end | N.D | 0.68 |
| | Removal efficiency | 99.42 | 92.16 |
| | (%) | | |
| Example 3 | Front end | 6.29 | 12.02 |
| | Rear end | N.D | 1.12 |
| | Removal efficiency | 99.63 | 90.68 |
| | (%) | | |
| Comparative | Front end | 7.19 | 28.08 |
| Example 1 | Rear end | 0.02 | 3.17 |
| | Removal efficiency | 99.72 | 88.71 |
| | (%) | | |

Referring to Table 2, in the case of the examples, the removal efficiency for harmful substances was high even at a low concentration, and removal rates for both acidic gases and basic gases were improved.

What is claimed is:

1. A chemical filter comprising:
a chemical filter media; and
a resin layer formed on an outer surface of the chemical filter media, the resin layer having a tensile strength of 20 kgf/cm² to 90 kgf/cm².

2. The chemical filter according to claim 1, wherein the resin layer has an elongation of 20% to 350%.

3. The chemical filter according to claim 1, wherein the resin layer has a maximum load of 4 kgf to 20 kgf.

4. The chemical filter according to claim 1, wherein the resin layer has a thickness of 1.0 mm to 10.0 mm.

5. The chemical filter according to claim 1, wherein the resin layer comprises a hot-melt resin.

6. The chemical filter according to claim 5, wherein the resin layer comprises an ethylene-based copolymer.

7. The chemical filter according to claim 1, wherein the outer surface of the chemical filter media comprises a first surface and a second surface which face each other in a longitudinal direction, and a third surface and a fourth surface which face each other in a width direction perpendicular to the longitudinal direction.

8. The chemical filter according to claim 7, wherein the resin layers are formed on the first surface and the second surface.

9. The chemical filter according to claim 8, further comprising a support member coupled to the third surface and the fourth surface of the chemical filter media.

10. The chemical filter according to claim 7, wherein the resin layers are formed on all of the first surface, the second surface, the third surface and the fourth surface.

11. The chemical filter according to claim 1, further comprising a filter frame in which the chemical filter media is housed.

12. The chemical filter according to claim 11, wherein the resin layer is in direct contact with the filter frame.

13. A method of manufacturing a chemical filter, the method comprising:
preparing a chemical filter media;
bending the chemical filter media in a zigzag shape; and
applying a hot-melt resin to the outer surface of the chemical filter media to form a resin layer, wherein the resin layer has a tensile strength adjusted to 20 kgf/cm² to 90 kgf/cm².

14. The method according to claim 13, further comprising assembling the chemical filter media on which the resin layer is formed to a filter frame.

15. The method according to claim 14, wherein the chemical filter media is coupled to the filter frame so that the resin layer is fixed by coming into contact with the filter frame.
